(19) United States
(12) Patent Application Publication
(10) Pub. No.: US 2023/0223861 A1
(43) Pub. Date: Jul. 13, 2023

(54) ELECTRICAL POWER CONVERTER

(71) Applicant: PRODRIVE TECHNOLOGIES INNOVATION SERVICES B.V., Son en Breugel (NL)

(72) Inventor: Jordi EVERTS, Son en Breugel (NL)

(21) Appl. No.: 17/997,810

(22) PCT Filed: May 3, 2021
(86) PCT No.: PCT/EP2021/061592

§ 371 Date: Nov. 2, 2022

(30) Foreign Application Priority Data
May 4, 2020 (NL) 2025504

(51) Int. Cl. H02M 7/219; H02M 1/00; B60L 53/20; H02J 7/02; H02M 1/42; H02M 3/158

(52) U.S. Cl. CPC H02M 7/219; H02M 1/007; B60L 53/20; H02J 7/02; H02M 1/4216; H02M 1/4233; H02M 3/158

(57) ABSTRACT

A three-phase AC to DC converter includes a first converter stage for converting between three phase voltages at three phase terminals and a first signal at a first intermediate node and a second intermediate node. A phase selector is configured to selectively connect the three phase terminals to a third intermediate node. The converter includes a second converter stage, a DC link connecting the first and second converter stages, and a galvanically isolated DC/DC converter stage having a first side connected to output nodes of the second converter stage and a first common node. A second side of the DC/DC converter stage is galvanically isolated from the first side. The first common node is connected to the third intermediate node. The difference of a first current applied to the DC/DC converter at output nodes of the second converter stage is provided at the third intermediate node.

### TECHNICAL FIELD

The present disclosure relates to the field of electrical power conversion. In particular, the present disclosure relates to an electrical converter for converting between three phase AC and DC with galvanic isolation.

### BACKGROUND ART

A typical three-phase galvanically isolated power supply, such as those used for charging battery driven electrical vehicles, comprises a three-phase rectifier with power factor correction (PFC) unit coupled to an isolated DC/DC converter unit. The isolated DC/DC converter unit converts power between the DC output of the three-phase rectifier unit, having typical voltage levels in the range of 700-800V, and the battery of the vehicle, having typical voltage levels in the range of 250-450V. In such cases where the input voltage (e.g. 700-800V) of the DC/DC converter unit is significantly higher than the output voltage (e.g. 250-450V) of the DC/DC converter unit, the isolated DC/DC converter unit often comprises two series-in, parallel-out coupled isolated DC/DC converters.

Barbosa P. et al., “Analysis and evaluation of the two-switch three-level boost rectifier”, 32^{nd} annual IEEE Power Electronics Specialists Conference 2001 Conference proceedings, vol. 3, 17 Jun. 2001, pp. 1659-1664, describes in relation to FIG. 3(a) a three-phase power supply comprising a boost type rectifier unit and two isolated DC/DC converters connected across the output capacitors of the boost rectifier. The rectifier unit comprises an input filter with inductors coupled to each of the phase inputs, a passive three-phase bridge rectifier, a boost circuit and two output capacitors sharing the DC bus voltage.

One drawback associated with the above power supplies is that they tend to become bulky and expensive.

Silva M. et al., “Isolated Swiss-Forward Three-Phase Rectifier with Resonant Reset”, IEEE Transactions on Power Electronics, Vol. 31, No. 7, 2016, pp. 4795-4808 describe a modified Swiss-type rectifier. PFC operation of the Swiss Rectifier is basically achieved by a combination of two stacked DC/DC buck converters and an active selector circuit comprising three bidirectional switches connected to the common node of the DC/DC buck converters in order to allow for active third-harmonic current injection. In their modified rectifier, the two DC/DC buck converters are replaced by two isolated DC/DC converters. This obviates the need of providing a secondary isolated stage. One drawback of the above converter is that the input voltage applied to the isolated DC/DC converters goes to zero at the crossings of the AC input phase voltages, resulting in poor controllability of the isolated DC/DC converters at these crossings leading to higher total harmonic distortion of the AC input currents. Also the isolated DC/DC converters experience a wide input voltage range resulting in an inefficient operation of the isolated DC/DC converters, requiring over dimensioning the isolated DC/DC converters.

### SUMMARY

There is a need in the art to provide an improved galvanically isolated three-phase AC/DC power supply. In particular, it is an object of the present disclosure to provide such power supplies which are more compact and more economical. It is an object to provide such power supplies which have similar or even improved performance characteristics over prior art power supplies of the above kind.

According to the present disclosure, there is therefore provided an electrical converter for converting an AC signal having at least three phases into a galvanically isolated DC signal or vice versa, as set out in the appended claims.

An electrical converter according to the present disclosure comprises (at least) three phase terminals, and two DC terminals, a first converter stage, a second converter stage and a third converter stage. The first converter stage comprises conversion circuitry configured for converting between the three phase voltages provided at the three phase terminals and a first signal provided at a first intermediate node and a second intermediate node. The conversion circuitry can be a bridge converter, in particular comprising a bridge leg for each of the at least three phase terminals. The first converter stage further comprises a phase selector comprising first active switches configured to selectively connect the three phase terminals to a third intermediate node.

The second converter stage is configured for converting between a second signal at a fourth intermediate node and a fifth intermediate node and a third signal at a sixth intermediate node and a seventh intermediate node. The second converter stage comprises or consists of a boost circuit, comprised of a first boost circuit and a second boost circuit series stacked between the sixth and seventh intermediate node.

A link, in particular a DC-link, connects the first intermediate node to the fourth intermediate node, and the second intermediate node to the fifth intermediate node. The link can comprise a differential mode filter, particularly operably coupled to the second converter stage.

The third converter stage comprises or consists of a galvanically isolated DC/DC converter stage comprising a first side and a second side galvanically isolated from each other. The first side is connected to the sixth intermediate node, a first common node and the seventh intermediate node. The DC terminals are connected to the second side of the DC/DC converter stage. The first common node is operably connected to the third intermediate node and the DC/DC converter stage is configured to be operated such that a difference of a first current applied to the DC/DC converter at the sixth intermediate node and a second current applied to the DC/DC converter at the seventh intermediate node is provided at the third intermediate node. The DC/DC converter stage can be built as a multi-port DC/DC converter, having three ports at the first side, or alternatively as two DC/DC converters wherein the first sides are stacked between the sixth and seventh intermediate nodes and having as common node the first common node.

The first and second boost circuits have a second common node. According to one advantageous aspect of the present disclosure, the first common node (of the third converter stage) and the second common node (of the second converter stage) are not connected, i.e. they are free from a direct or equipotential link between the two nodes. Likewise, the second common node is advantageously not connected to the third intermediate node (i.e. not connected through a direct or equipotential link or connection). However, the first common node and the third intermediate node are advantageously connected (i.e. through a direct or equipotential link).

One advantage of the electrical converter according to the present disclosure is that the isolated DC/DC converter stage acts as a current injection circuit, and hence no additional third harmonic current injection circuit is necessary to obtain sinusoidal mains currents with low total harmonic distortion and/or unity power factor. Nevertheless, by operating the DC/DC (third) converter stage as a third harmonic current injection circuit, it is advantageously obtained that the voltages at the first side of the DC/DC converter stage (between the sixth intermediate node and the first common node and between the first common node and the seventh intermediate node) remain positive and different from zero, in particular at the crossings of the AC phase voltages. This is made possible by separating the first common node from the second common node and results in better controllability of the third converter stage. Furthermore, electrical energy storage elements required for the current injection circuit to operate can be dispensed with, since they are taken over by components already present in the isolated DC/DC converter stage. Electrical converters according to the present disclosure hence are more compact, require less components and therefore are more economical.

According to a second aspect of the present disclosure, there is provided a battery charging system, such as for charging the battery of an electric vehicle, or an electric motor drive system, comprising a power supply, the power supply comprising the electrical converter as described herein.

### BRIEF DESCRIPTION OF THE FIGURES

Aspects of the present disclosure will now be described in more detail with reference to the appended drawings, wherein same reference numerals illustrate same features and wherein:

FIG. 1 schematically shows an electrical power converter according to the present disclosure.

FIG. 2 represents the AC three phase grid voltages and currents.

FIG. 3 represents the voltage and current at the upper intermediate node.

FIG. 4 represents the voltage and current at the lower intermediate node.

FIG. 5 represents the voltage and current at the middle intermediate node.

FIG. 6 represents the voltages of FIGS. 3-5 in a single diagram, together with the boost voltages at the upper and lower boost nodes during a whole period (360°) of the AC grid voltage.

FIG. 7 represents the input voltages to the isolated DC/DC converters during a whole period (360°) of the AC grid voltage.

FIG. 8 represents the input currents to the isolated DC/DC converters during a whole period (360°) of the AC grid voltage.

FIG. 9 represents the output power of the isolated DC/DC converters during a whole period (360°) of the AC grid voltage.

FIG. 10 represents a topology of a galvanically isolated DC/DC converter for use in electrical converters according to the present disclosure.

FIG. 11 represents a topology of a multi-port galvanically isolated DC/DC converter for use as a third converter stage in electrical converters according to the present disclosure.

FIG. 12 represents a diagram of a battery charging system according to aspects of the present disclosure.

### DESCRIPTION OF EMBODIMENTS

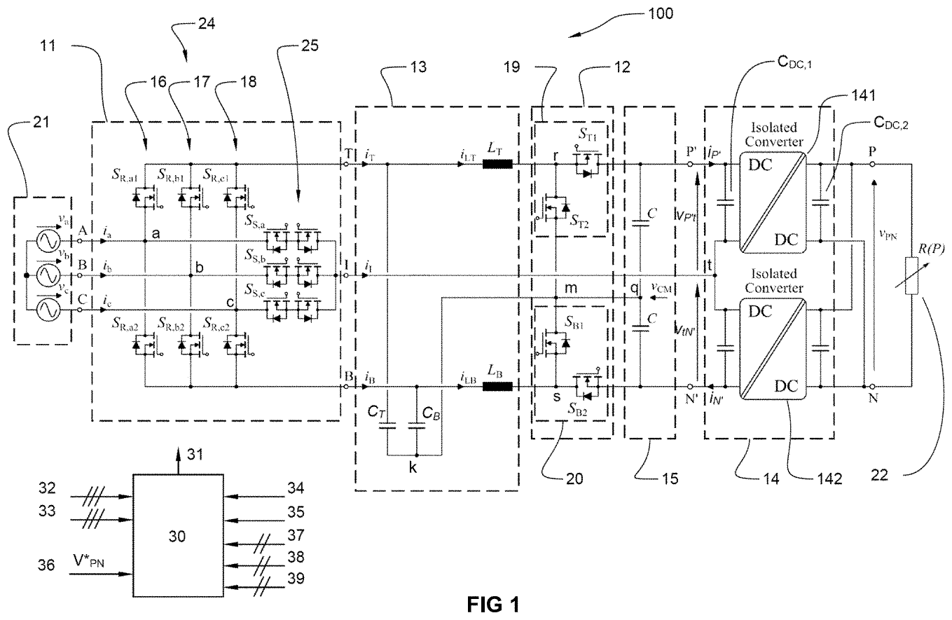

Referring to FIG. 1, an exemplary embodiment of electrical power converter 100, comprises a first converter stage 11, a second converter stage 12, an input filter 13, and an output filter 15. Electrical converter 100 further comprises a third converter stage 14.

The electrical converter 100 is an AC-to-DC converter that has three phase input terminals A, B, C which are connected to a three-phase voltage of a three-phase AC grid 21, and two DC terminals P, N which for example may be connected to a DC load 22, such as a high voltage (e.g. 250-450V) battery of an electric car.

The first converter stage 11 comprises three phase nodes a, b, c that are connected to the three phase input terminals A, B, C, and three output nodes T, I, B. These output nodes may be seen as an upper intermediate node T, a lower intermediate node B, and a middle intermediate node I.

The first converter stage 11 comprises a conversion circuitry 24 for conversion between a three-phase AC signal with three phase voltages provided at the three phase nodes a, b, c and an intermediate (DC) signal between the upper intermediate node T and the lower intermediate node B. When the conversion is from AC to DC, the conversion circuitry 24 functions as a rectifier, and when the conversion is from DC to AC, the conversion circuitry functions as an inverter. The conversion circuitry 24 advantageously comprises a three-phase bridge circuitry consisting of three bridge legs 16, 17, 18 wherein each bridge leg can comprise two active (bidirectional) or passive semiconductor switching devices connected in the form of a half bridge configuration. In the example of FIG. 1, the bridge circuitry 24 acts as a three phase bridge rectifier comprising a pair of active switching devices in each bridge leg: S_{R,a1} and S_{R,a2} for leg 16, S_{R,b1} and S_{R,b2} for leg 17, S_{R,c1} and S_{R,c2} for leg 18. Alternatively, diodes can be used instead of the active switching devices to obtain a passive, unidirectional three phase bridge rectifier.

The first converter stage 11 further comprises a phase selector 25 comprising three voltage-bidirectional semiconductor switching devices (S_{S,a}, S_{S,b}, and S_{S,c}) allowing for bidirectional interruption of electric current and bidirectional blocking of voltage. Each of these current-bidirectional switching devices can comprise two anti-series connected active semiconductor switching devices.

Each active semiconductor switching device of the bridge circuitry 24 and/or the phase selector 25 advantageously comprises an anti-parallel diode. By way of example, Metal Oxide Field Effect Transistors (MOSFETs) are used for the active semiconductor switching devices, and each may include an internal anti-parallel body diode that may replace an external anti-parallel diode.

The second converter stage 12 comprises, or consists of, two stacked boost circuits 19, 20. Each boost circuit 19, 20 advantageously comprises a first boost switch (S_{T2} for the upper boost circuit 19 and S_{B1} for the lower boost circuit 20) and second boost switch (S_{T1} for the upper boost circuit 19 and S_{B2} for the lower boost circuit 20) connected in a half-bridge configuration. The first and second boost switches can be active, bidirectional switches, allowing bidirectional current flow, but current interruption in one sense only, e.g. MOSFET switching devices with anti-parallel (body) diode. Alternatively, the second boost switches S_{T1} and S_{B2} can be replaced by diodes. The middle node (switch node) r of the upper boost circuit 19 is connected to upper intermediate voltage node T via an upper boost inductor L_{T}. The middle node (switch node) s of the lower boost circuit 20 is connected to lower intermediate voltage node B via a lower boost inductor L_{B}. The first switches of the upper and lower boost circuits 19, 20 are connected to each other in common node m of the upper and lower boost circuits 19, 20. The second boost switch S_{T1} of the upper boost circuit 19 is connected between the middle node r and an upper boost node P′. The second boost switch S_{B2} of the lower boost circuit 20 is connected between the middle node s and a lower boost node N′.

The upper boost inductor L_{T} and the lower boost inductor L_{B} form the inductive part of the input filter 13. The capacitive part of the input filter 13 is advantageously formed by two high-frequency (HF) filter capacitors C_{T}, C_{B} each connected between the respective upper and lower intermediate node T, B, and a common node, which may be further connected to the common node m between the boost circuits 19 and 20. Generally, it is advantageous that the two capacitors C_{T}, C_{B} have substantially equal capacitance in order to symmetrically load the AC grid.

The output filter 15 comprises two series connected output filter capacitors C, advantageously of equal capacitance, connected across the outputs P′ and N′ of the upper and lower boost circuits 19, 20 respectively. P′ and N′ will hereinafter be referred to as upper and lower boost nodes, respectively. A midpoint node q between the output filter capacitors C is advantageously connected to the common node m between the upper and lower boost circuits 19, 20. It is alternatively possible to provide a single output filter capacitor connected across the upper and lower boost nodes P′ and N′.

The upper boost circuit 19 is connected between the upper boost node P′ and the common node m (advantageously in parallel with the upper output filter capacitor), and is arranged in a way that current can flow from the upper intermediate node T to the upper boost node P′ (or vice versa) via switch S_{T1} when switch S_{T2} is open (not conducting, off state), and current can flow from the upper intermediate node T to the common node m (or vice versa) via the switch S_{T2} when the switch S_{T2} is closed (conducting, on state). At least boost switch S_{T2} of the boost circuit 19 is an actively controlled semiconductor switching device, for example a MOSFET, which may be operated by pulse width modulation. In case the switch S_{T1} is replaced by a diode D_{T1}, current can flow from the upper intermediate node T to the upper boost node P′ via diode D_{T1} when switch S_{T2} is open (not conducting, off state) but current cannot flow from the upper boost node P′ to the upper intermediate node T.

The lower boost circuit 20 is connected between the common node m and the lower boost node N′ (advantageously in parallel with the lower output filter capacitor), and is arranged in a way that current can flow from the lower boost node N′ to the lower intermediate node B (or vice versa) via the switch S_{B2} when the switch S_{B1} is open (not conducting, off state), and current can flow from the common node m to the lower intermediate node B (or vice versa) via the switch S_{B1} when the switch S_{B1} is closed (conducting, on state). At least boost switch S_{B1} of the boost circuit 20 is an actively controlled semiconductor switching device, for example a MOSFET, which may be operated by pulse width modulation. In case the switch S_{B2} is replaced by a diode D_{B2}, current can flow from the lower boost node N′ to the lower intermediate node B via diode D_{B2} when switch S_{B1} is open (not conducting, off state) but current cannot flow from the lower intermediate node B to the lower boost node N′.

The electrical converter optionally comprises a neutral terminal (not shown) for connecting to the neutral conductor of the grid. The neutral terminal can be connected to the common node k of the high-frequency (HF) filter capacitors C_{T}, C_{B} and/or to the common node m of the first and second boost circuits 19, 20. Referring to FIG. 1, the common node m is connected to the common node k of the high-frequency (HF) filter capacitors C_{T}, C_{B}.

The third converter stage 14 is formed by two galvanically isolated DC/DC converters 141, 142 whose inputs are connected in series across the upper and lower boost nodes P′ and N′ and whose outputs are connected to the output terminals P, N of the converter 100, either through a parallel connection as shown in FIG. 1, or through a series connection. It is possible to provide a switching device allowing for commutating the outputs of the isolated DC/DC converters 141, 142 between parallel connection and series connection across the output terminals P, N. The common node t between the inputs of the isolated DC/DC converters 141, 142 is advantageously directly connected to the middle intermediate node I without there being any inductors in the path between middle intermediate node I and t.

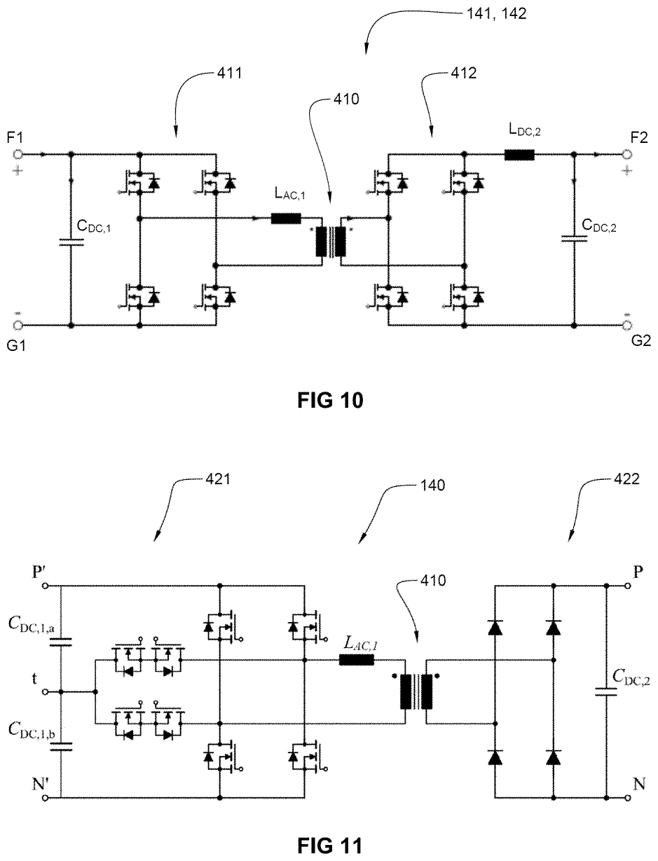

Any suitable galvanically isolated DC/DC converter as known in the art can be used for converters 141 and 142. One possible DC/DC converter topology for converters 141 and 142 is represented in FIG. 10 as a bidirectional full bridge DC/DC converter. Such a converter comprises a first side with nodes F1, G1 and a first full bridge converter circuit 411, and a second side with nodes F2, G2 and a second full bridge converter circuit 412. The first and second full bridge converter circuits 411, 412 are coupled through a transformer 410 e.g. having 1:1 winding ratio, even though any other suitable winding ratio can be used, and performing the galvanic isolation. The switches in the bridge legs of the first full bridge converter circuit 411 are active semiconductor switching devices. The switches in the bridge legs of the second full bridge converter circuit 412 can be active or passive semiconductor switching devices. In case active switches are used in the second full bridge converter circuit 412, the isolated DC/DC converter can be used for bidirectional power flow.

The first side nodes F1, G1 are connected to nodes P′ and t respectively for the upper isolated DC/DC converter 141 and to nodes t and N′ respectively for the lower isolated DC/DC converter 142. The second side nodes F2, G2 are connected to the DC terminals P, N of the converter 100, either through a series or parallel connection between converters 141 and 142.

The topology of FIG. 10 is just an exemplary embodiment of possible converter topologies that can be used for DC/DC converters 141 and 142. By way of example, either one of the inductor L_{AC,1} at the first side and L_{DC,2} at the second side can be omitted.

Referring to FIG. 11, an exemplary embodiment of a multi-port galvanically isolated DC/DC converter 140 can replace the DC/DC converters 141 and 142 to act as the third converter stage 14. This converter comprises a first side 421 with nodes connected to nodes P′, t and N′ as indicated in FIG. 11 and which acts in analogy of two stacked active full bridges. The second side 422 can comprise a full bridge converter circuit with active or passive semiconductor switches.

Further suitable topologies for DC/DC converters in the third converter stage 14 are described in Krismer Florian, Modeling and Optimization of Bidirectional Dual Active Bridge DC-DC Converter Topologies, Dissertation ETH Zürich No. 19177, 2010, available online:

https://www.pes-publications.ee.ethz.ch/uploads/tx_ethpublications/Krismer_2011_03_17_Modeling_and_Op timization_of_Bidirectional_Dual_Active_Bridge_DC-DC_Converter_Topologies.pdf

Referring again to FIG. 1, the electrical power converter 100 can comprise a control unit 30 which advantageously controls all the active semiconductor switching devices of the electrical converter 100, sending control signals to each switch via a communication interface 31. In particular, semiconductor switching devices S_{R,a1}, S_{R,a2}, S_{R,b1}, S_{R,b2}, S_{R,c1}, S_{R,c2} of bridge circuitry 24, switching devices S_{S,a}, S_{S,b}, and S_{S,c} of phase selector 25, and boost switches S_{T2}, S_{B1}, S_{T1} and S_{B2} are actively controlled by controller 30 through interface 31. Boost switches S_{T2}, S_{B1}, S_{T1} and S_{B2} and possibly the other active switching devices as well are in particular controlled based on pulse width modulation. Furthermore, the control unit can comprise one or more measurement input ports (32, 33, 34, 35, 37, 38, 39), for receiving measurements of one or more of:
32: the AC-grid phase voltages vₐ, v_{b}, v_{c};
33: the intermediate currents i_{T}, i_{B}, i_{I};
34: the DC bus voltage V_{PN};
35: the mid-point voltage V_{CM} of the output filter capacitors at node q;
37: the DC bus voltages v_{p′q}, v_{qN′} of the output filter 15;
38: the input voltages v_{p′t}, v_{tN′} of the isolated DC/DC converters;
39: the input currents i_{p′}, i_{N′} of the isolated DC/DC converters;
   and an input port 36 to receive a set-value, which may be a requested DC output voltage V*_{PN}.

In addition, the control unit 30 advantageously controls the active switches of at least the first side 411, 421 of the isolated DC/DC converters 141, 142 or 140.

The electrical converter 100 basically combines a boost type three-phase rectifier formed by the first converter stage 11, input filter 13, second power (boost) stage 12 and output filter 15, with two series-in connected isolated DC/DC converters. According to the present disclosure, the isolated DC/DC converter stage together with the phase selector 25 act as a third-harmonic current injection circuit, obviating the need for an additional conventional buck-boost circuit and boost inductor, resulting in a more compact design.

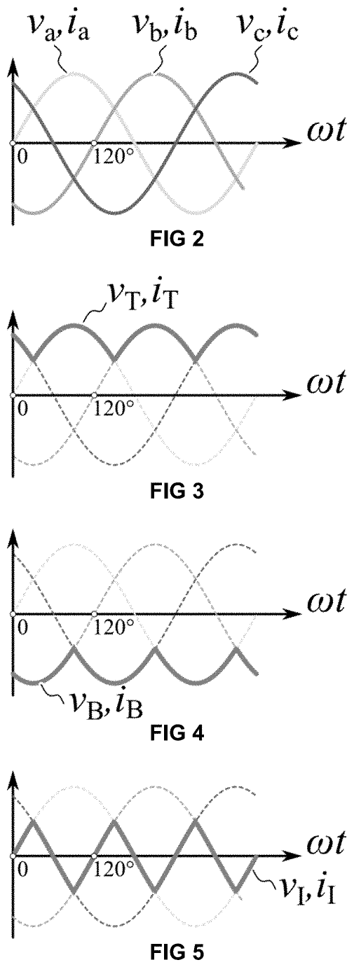

When a three-phase AC grid 21 is connected to the input terminals A, B, C with AC grid phase voltages vₐ, v_{b}, v_{c} (FIG. 2), the three phase bridge circuitry 24 acts as a rectifier and ensures that the instantaneous highest voltage of the AC grid phase voltages Vₐ, V_{b}, V_{c} is applied to the upper intermediate node T, obtaining at T a voltage v_{T} as shown in FIG. 3, and the instantaneous lowest voltage of the AC grid phase voltages Vₐ, v_{b}, v_{c} is applied to the lower intermediate node B, obtaining at B a voltage v_{B} as shown in FIG. 3. To achieve this, the corresponding phase connection node a, b, or c is connected with the intermediate node T or B via the upper respectively lower switch of the corresponding bridge leg 16, 17, 18, while the corresponding selector switch S_{S,a}, S_{S,b}, or S_{S,c} is open (not conducting, off state). The phase selector switches S_{S,a}, S_{S,b}, and S_{S,c} are controlled, e.g. by controller 30, such that the instantaneous intermediate voltage between the highest voltage and the lowest voltage of the AC grid phase voltages vₐ, v_{b}, v_{c} is applied to the middle intermediate node I, obtaining at I a voltage v_{I} as shown in FIG. 5. The switching states of the selector switches (S_{S,a}, S_{S,b}, and S_{S,c}) are ‘on’ or ‘off’ continuously during whole particular 60° sectors within the period (360°) of the AC mains voltage. Also the switches of the bridge circuitry 24 are ‘conducting’ or ‘not conducting’ during whole particular sectors, e.g. of 60°, within the period (360°) of the AC mains voltage. The combination of states of the switches of the bridge rectifier and the phase selector is unique for every 60° sector of the three-phase AC input voltage and depends on the voltage value of the AC grid phase inputs (A, B, C). The sequence of the 6 unique states of the switches repeats itself every period (360°) of the AC mains voltage.

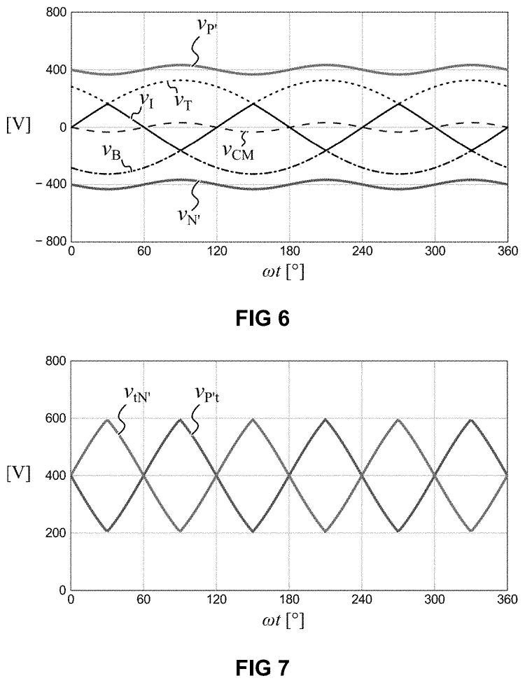

Referring to FIG. 6, the upper and lower boost stages 19, 20 ensure that the voltage vₚ, at upper boost node P′ is stepped up compared to the voltage v_{T} at upper intermediate node T and that the voltage v_{N′} at lower boost node N′ is stepped down compared to the voltage v_{B} at the lower intermediate node B. When two output filters C with equal capacitance are used for the output filter 15, and the midpoint node q between the output filter capacitors C is connected to the common node m between the upper and lower boost circuits 19, 20 and to the common node of filter capacitors C_{T} and C_{B} of input filter 13, the midpoint potential at node q can be controlled to be equal to the star-point potential of the three-phase AC grid 21, i.e., v_{CM}=0, or controlled to have a third-harmonic voltage content as shown in FIG. 6. This can be achieved by appropriate control of the boost circuits 19, 20. In particular, boost circuits 19 and 20 are able to inject a common offset voltage to nodes r and s by adding a common offset to the PWM duty-cycles of switches S_{T2}, S_{B1}. This common voltage reflects into a controlled v_{CM}.

Referring to FIG. 7, the second converter stage 12 (boost stage) ensures that the DC voltage v_{P′t} at the input of the upper DC/DC converter 141 (between nodes P′ and t) and DC voltage v_{tN′} at the input of the lower DC/DC converter 142 (between nodes t and N′) always remain above zero at the crossings of the AC grid phase voltages. This ensures a good controllability of the isolated DC/DC converters in all operating points, resulting in improved total harmonic distortion of the AC grid currents and improved efficiency of the isolated DC/DC converters.

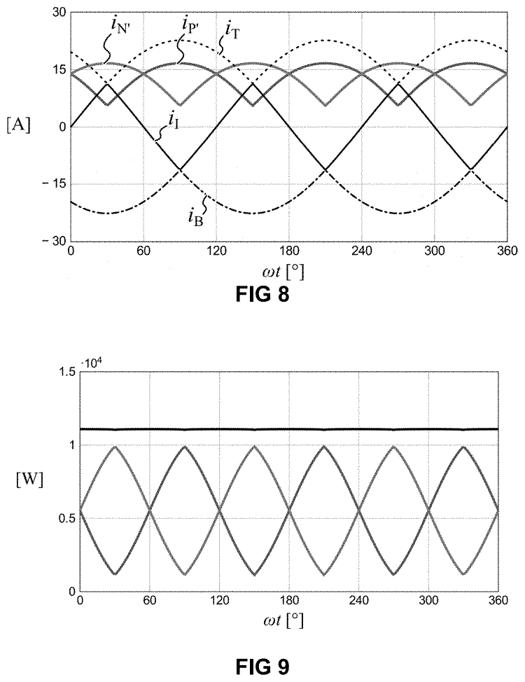

Referring to FIG. 8, the input currents i_{p′} and i_{N′} through nodes P′ and N′ (and hence through the isolated DC/DC converter stage 14 can be controlled to always be different from zero. Input currents i_{p′} and i_{N′} can be (independently) controlled, e.g. through appropriate (PWM) control of the active switches of the (first side 411, 421 of the) isolated DC/DC converter(s) 141, 142, or 140, by control unit 30, such that the difference of i_{p′} and i_{N′} results in the desired third-harmonic injection current i_{I} (FIG. 5) through intermediate node I. As a result, the need for an additional third harmonic current injection circuit to obtain the desired third-harmonic current i_{I} is obviated, yielding a more compact design.

The input filter 13 in the DC-link between nodes T and B on the one hand, and nodes r and s on the other, can comprise only two inductors L_{T} and L_{B} operably coupled to the upper intermediate node T and lower intermediate node B respectively, without there being any inductor operably coupled to the middle intermediate node I. In other words, the current injection line between the middle intermediate node I and the common node t between the inputs of the isolated DC/DC converters can be free of inductive energy storage elements. Alternatively, a third inductor can be provided between nodes I and t.

Electrical converters according to the present disclosure are advantageously used for converting from three-phase AC to DC and/or vice versa. Particularly useful applications are in power supply units of battery chargers, in particular for charging electric batteries of electric (motor-driven) vehicles.

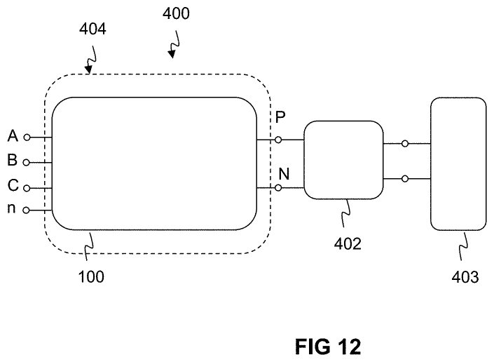

Referring to FIG. 12, a battery charging system 400 comprises a power supply unit 404. The power supply unit 404 is coupled on one side to the AC grid through terminals A, B, C, possibly additionally to the neutral conductor n and on the other side (at DC terminals P, N) to an interface 402, e.g. comprising a switch device, which allows to connect the power supply unit 404 to a battery 403. The power supply unit 404 comprises the electrical converter 100 as described hereinabove. The power supply unit 404 can further comprise a pair of coils which are inductively coupled through air, such as in case of wireless power transfer (not shown). In some cases, the interface 402 can comprise a plug and socket, e.g. in wired power transfer. Alternatively, the plug and socket can be provided at the input (e.g., at nodes A, B, C, n).

Aspects of the present disclosure are set out in the following numbered clauses.
1. Electrical converter (100) for converting between an AC signal comprising three phase voltages and a galvanically isolated DC signal, comprising:
   three phase terminals (A, B, C) and two DC terminals (P, N),
   a first converter stage (11) comprising a conversion circuitry (24) configured for converting between the three phase voltages at the three phase terminals and a first signal at a first intermediate node (T) and a second intermediate node (B), and a phase selector (25) comprising first active switches (S_{S,a}, S_{S,b}, S_{S,c}) configured to selectively connect the three phase terminals (A, B, C) to a third intermediate node (I),
   a second converter stage (12) configured for converting between a second signal at a fourth intermediate node (r) and a fifth intermediate node (t) and a third signal at a sixth intermediate node (P′) and a seventh intermediate node (N′), wherein the second converter stage comprises a boost circuit (19, 20) operably coupled to the sixth and seventh intermediate nodes (P′, N′),
   a link (13) connecting the first intermediate node (T) to the fourth intermediate node, and the second intermediate node (B) to the fifth intermediate node, and
   a third converter stage (14), comprising a galvanically isolated DC/DC converter stage (141, 142, 140) comprising a first side connected to the sixth intermediate node (P′), a first common node (t) and the seventh intermediate node (N′), wherein the DC terminals (P, N) are connected to a second side of the DC/DC converter stage galvanically isolated from the first side, wherein the first common node (t) is operably connected to the third intermediate node (I) and wherein the DC/DC converter stage is configured to be operated such that a difference of a first current (iₚ,) applied to the DC/DC converter (141) at the sixth intermediate node (P′) and a second current (i_{N},) applied to the DC/DC converter at the seventh intermediate node (N′) is provided at the third intermediate node (I).
2. Electrical converter of clause 1, wherein the phase selector (25) is configured to selectively connect the three phase terminals (A, B, C) to the first common node (t) along a current path free of inductive storage elements.
3. Electrical converter of clause 1 or 2, wherein the boost circuit comprises a first boost circuit (19) and a second boost circuit (20) stacked between the sixth and seventh intermediate nodes, wherein the first and second boost circuits have a second common node (m).
4. Electrical converter of clause 3, comprising a neutral terminal for connecting to a neutral conductor carrying a neutral phase of the AC signal, wherein the neutral terminal is connected to the second common mode (m).
5. Electrical converter of any one of the preceding clauses, wherein the link (13) comprises a capacitive part connecting the first intermediate node (T) and the second intermediate node (B) through at least one capacitor (C_{T}, C_{B}).
6. Electrical converter of clauses 4 and 5, wherein capacitive part comprises a third common node and wherein the neutral terminal is connected to the third common node.
7. Electrical converter of any one of the preceding clauses, wherein the link (13) comprises a first inductive storage element (L_{T}) and preferably a second inductive storage element (L_{B}), operably coupled to the second converter stage.
8. Electrical converter of any one of the preceding clauses, comprising a control unit (30), wherein the control unit is configured to operate the first active switches (S_{S,a},S_{S,b}, S_{S,c}) for connecting a phase terminal (A, B, C) having a lowest instantaneous absolute voltage value of the three phase voltages to the third intermediate node (I).
9. Electrical converter of clause 8, comprising measuring means for measuring a parameter of the third signal and a signal at the third intermediate node (I), operably coupled to the control unit (30).

10. Electrical converter of any one of the preceding clauses, wherein the galvanically isolated DC/DC converter stage comprises a first galvanically isolated DC/DC converter (141) comprising a first side connected to the sixth intermediate node (P′) and the first common node (t) and a second galvanically isolated DC/DC converter (142) comprising a first side connected to the first common node (t) and the seventh intermediate node (N′), wherein the DC terminals (P, N) are connected to second sides of the first and second DC/DC converter.
11. Electrical converter of clause 10, wherein the second sides of the first and second isolated DC/DC converters (141, 142) are connected in parallel or in series across the DC terminals (P, N).
12. Battery charging system, in particular for charging a battery of an electric vehicle, comprising a power supply unit, the power supply unit comprising the electrical converter (100) of any one of the preceding clauses.
13. Electric motor drive system, comprising a power supply unit, the power supply unit comprising the electrical converter (100) of any one of the clauses 1 to 11.

1. An electrical converter for converting between an AC signal comprising three phase voltages and a galvanically isolated DC signal, the electrical converter comprising:
three phase terminals (A, B, C) and two DC terminals (P, N);
a first converter stage comprising a conversion circuitry configured to convert between the three phase voltages at the three phase terminals and a first signal at a first intermediate node (T) and a second intermediate node (B), and a phase selector comprising first active switches (S_{S,a}, S_{S,b}, S_{S,c}) configured to selectively connect the three phase terminals (A, B, C) to a third intermediate node (I);
a second converter stage configured for converting between a second signal at a fourth intermediate node (r) and a fifth intermediate node (s) and a third signal at a sixth intermediate node (P′) and a seventh intermediate node (N′), wherein the second converter stage comprises a boost circuit (19, 20) operably coupled to the sixth and seventh intermediate nodes (P′, N′);
a link connecting the first intermediate node (T) to the fourth intermediate node, and the second intermediate node (B) to the fifth intermediate node; and
a third converter stage, comprising a galvanically isolated DC/DC converter stage comprising a first side connected to the sixth intermediate node (P′), a first common node (t) and the seventh intermediate node (N′), wherein the DC terminals (P, N) are connected to a second side of the DC/DC converter stage galvanically isolated from the first side, wherein the first common node (t) is operably connected to the third intermediate node (I) and wherein the DC/DC converter stage is configured to be operated such that a difference of a first current (i_{P′}) applied to the DC/DC converter stage at the sixth intermediate node (P′) and a second current (i_{N′}) applied to the DC/DC converter stage at the seventh intermediate node (N′) is provided at the third intermediate node (I);
wherein the boost circuit comprises a first boost circuit and a second boost circuit stacked between the sixth and seventh intermediate nodes, wherein the first and second boost circuits have a second common node (m) being free from a direct link to the first common node (t) and the third intermediate node (I).

2. The electrical converter of claim 1, wherein the phase selector is configured to selectively connect the three phase terminals (A, B, C) to the first common node (t) along a current path free of inductive storage elements.

3. The electrical converter of claim 1, further comprising an output filter, the output filter comprising two series connected output filter capacitors (C) connected across the sixth intermediate node (P′) and the seventh intermediate node (N′), wherein a midpoint node (q) between the output filter capacitors (C) is connected to the second common node (m).

4. The electrical converter of claim 1, wherein the link comprises a capacitive part connecting the first intermediate node (T) and the second intermediate node (B) through at least one capacitor (C_{T}, C_{B}).

5. The electrical converter of claim 4, wherein the capacitive part comprises a third common node (k) connected to the second common node (m).

6. The electrical converter of claim 1, further comprising a neutral terminal for connecting to a neutral conductor carrying a neutral phase of the AC signal, wherein the neutral terminal is connected to the second common node (m).

7. The electrical converter of claim 1, wherein the link comprises a first inductive storage element (L_{T}) operably coupled to the second converter stage.

8. The electrical converter of claim 1, further comprising a control unit, wherein the control unit is configured to operate the first active switches (S_{S,a}, S_{S,b}, S_{S,c}) for connecting a phase terminal (A, B, C) having a lowest instantaneous absolute voltage value of the three phase voltages to the third intermediate node (I).

9. The electrical converter of claim 8, wherein the control unit comprises at least one measurement input port configured to receive a measurement of the third signal and of a signal at the third intermediate node (I).

10. The electrical converter of claim 1, wherein the galvanically isolated DC/DC converter stage comprises a first galvanically isolated DC/DC converter comprising a first side connected to the sixth intermediate node (P′) and the first common node (t) and a second galvanically isolated DC/DC converter comprising a first side connected to the first common node (t) and the seventh intermediate node (N′), wherein the DC terminals (P, N) are connected to second sides of the first and second DC/DC converter.

11. The electrical converter of claim 10, wherein the second sides of the first and second isolated DC/DC converters are connected in parallel or in series across the DC terminals (P, N).

12. A battery charging system, comprising a power supply unit, the power supply unit comprising the electrical converter of claim 1.

13. An electric motor drive system, comprising a power supply unit, the power supply unit comprising the electrical converter of claim 1.

14. The electrical converter of claim 7, wherein the link further comprises a second inductive storage element (L_{B}) operably coupled to the second converter stage.

15. The electrical converter of claim 1, wherein the galvanically isolated DC signal is a DC voltage.

16. The electrical converter of claim 1, wherein the first signal is a voltage between the first intermediate node (T) and the second intermediate node (B).

17. The electrical converter of claim 1, wherein the second signal is a voltage between the fourth intermediate node and the fifth intermediate node, or a first current at the fourth intermediate node and a second current at the fifth intermediate node.

18. An electrical converter for converting between an AC signal comprising three phase voltages and a galvanically isolated DC voltage, comprising:
three phase terminals (A, B, C) and two DC terminals (P, N),
a first converter stage comprising a conversion circuitry configured for converting between the three phase voltages at the three phase terminals and a first voltage between a first intermediate node (T) and a second intermediate node (B), and a phase selector comprising first active switches (S_{S,a}, S_{S,b}, S_{S,c}) configured to selectively connect the three phase terminals (A, B, C) to a third intermediate node (I),
a second converter stage configured for converting between a second signal at a fourth intermediate node (r) and a fifth intermediate node (s) and a third signal at a sixth intermediate node (P′) and a seventh intermediate node (N′), wherein the second converter stage comprises a boost circuit (19, 20) operably coupled to the sixth and seventh intermediate nodes (P′, N′),
a link connecting the first intermediate node (T) to the fourth intermediate node, and the second intermediate node (B) to the fifth intermediate node, and
a third converter stage, comprising a galvanically isolated DC/DC converter stage comprising a first side connected to the sixth intermediate node (P′), a first common node (t) and the seventh intermediate node (N′), wherein the DC terminals (P, N) are connected to a second side of the DC/DC converter stage galvanically isolated from the first side, wherein the first common node (t) is operably connected to the third intermediate node (I) and wherein the DC/DC converter stage is configured to be operated such that a difference of a first current (i_{P′}) applied to the DC/DC converter stage at the sixth intermediate node (P′) and a second current (i_{N′}) applied to the DC/DC converter stage at the seventh intermediate node (N′) is provided at the third intermediate node (I), wherein the boost circuit comprises a first boost circuit and a second boost circuit stacked between the sixth and seventh intermediate nodes, wherein the first and second boost circuits have a second common node (m) being free from equipotential links to the first common node (t) and to the third intermediate node (I).
